(19) United States
(12) Patent Application Publication
(10) Pub. No.: US 2006/0121891 A1
(43) Pub. Date: Jun. 8, 2006

(54) System and method for providing a dual mode phone feature proxy in a network environment

(75) Inventors: Ramanathan T. Jagadeesan, San Jose, CA (US); Bich T. Nguyen, Los Altos, CA (US); Christopher E. Pearce, Dallas, TX (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/003,201

(22) Filed: Dec. 3, 2004

(51) Int. Cl. H04M 3/42

(52) U.S. Cl. 455/417; 455/439

(57) ABSTRACT

A mobile station is provided that includes a first wireless interface operable to couple to a first wireless network, and a second wireless interface operable to couple to a second wireless network. A controller included in the mobile station is operable to negotiate a first wireless link with the first wireless network using the first wireless interface, to establish a communication session with a device using the first wireless link, to facilitate the communication session with a second wireless link with the second wireless network using the second wireless interface, and to invoke a selected one of a plurality of private branch exchange features. One or more of the features are delivered to the mobile station via a phone feature proxy function that is enabled by a mobility application that is operable to communicate with the mobile station.

### TECHNICAL FIELD OF THE INVENTION

The present invention relates generally to network communications, and, more particularly, to a system and a method for providing a dual mode phone feature proxy in a network environment.

### BACKGROUND OF THE INVENTION

Networking architectures have grown increasingly complex in communications environments. In addition, the augmentation of clients or end users wishing to communicate in various network environments has caused many networking configurations and systems to respond by adding elements to accommodate the increase in networking traffic and the various enhancements that have been provided by numerous communicative platforms. In recent years, a series of protocols and architectures have been developed in order to accommodate a diverse group of end users having various needs. Some of these protocols relate to issues associated with handoffs (or handovers).

As both public and private network systems grow in size and in sophistication, proper routing and efficient management of communication sessions and data flows becomes even more critical. In cases where protocols are unable to accommodate a given service or feature, an end user is precluded from enjoying the benefits of a given communication architecture. Advances in technology have resulted in the deployment of various types of wireless networks. However, while most of these wireless networks often provide service to adjacent and/or overlapping physical spaces, most cellular and enterprise network protocols are incompatible. Accordingly, the ability to provide an effective mechanism to properly process and direct communications for an end user seeking to realize the benefits provided by multiple network environments offers a significant challenge to network operators, component manufacturers, and system designers.

### SUMMARY OF THE INVENTION

In accordance with the present invention, techniques for supporting handoff between cellular and enterprise wireless networks are provided. According to some embodiments, these techniques enable a mobile station to maintain a communication session that is handed between cellular and enterprise wireless networks. In particular, these operations can enable a mobile station, alone or in combination with a mobility application, to utilize techniques that provide enterprise network features by using a feature proxy.

According to a particular embodiment, a mobile station is provided that includes a first wireless interface operable to couple to a first wireless network, and a second wireless interface operable to couple to a second wireless network. A controller included in the mobile station is operable to negotiate a first wireless link with the first wireless network using the first wireless interface, to establish a communication session with a device using the first wireless link, to facilitate the communication session with a second wireless link with the second wireless network using the second wireless interface, and to invoke a selected one of a plurality of private branch exchange features. One or more of the features are delivered to the mobile station via a phone feature proxy function that is enabled by a mobility application that is operable to communicate with the mobile station.

Embodiments of the invention provide various technical advantages. According to some embodiments, these techniques may reduce cost and increase performance by empowering the mobile station to select between available networks. Furthermore, by utilizing both cellular and enterprise networks, a mobile station may increase its range of use. In addition, handoff between cellular and enterprise networks may be provided with little or no change to service provider networks and/or enterprise networks. Also, these techniques may be used without modification of signal protocols and without dependence upon any existing signal protocol. Furthermore, using the disclosed techniques, trust boundaries between service providers and enterprises may be preserved. Hence, with the proffered architecture, features in the cellular network are offered to an end user without requiring a simultaneous voice and data connections. In addition, features may be invoked and realized during a handoff.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 illustrates a communication system having elements that support handoff between cellular and enterprise wireless networks;

FIG. 2 is a block diagram illustrating functional components of a mobility application from the communication system;

FIG. 3 is a block diagram illustrating functional components of a mobile station from the communication system; and

FIG. 4 is a flowchart illustrating a method for effecting handoff between cellular and enterprise wireless networks.

### DETAILED DESCRIPTION OF THE INVENTION

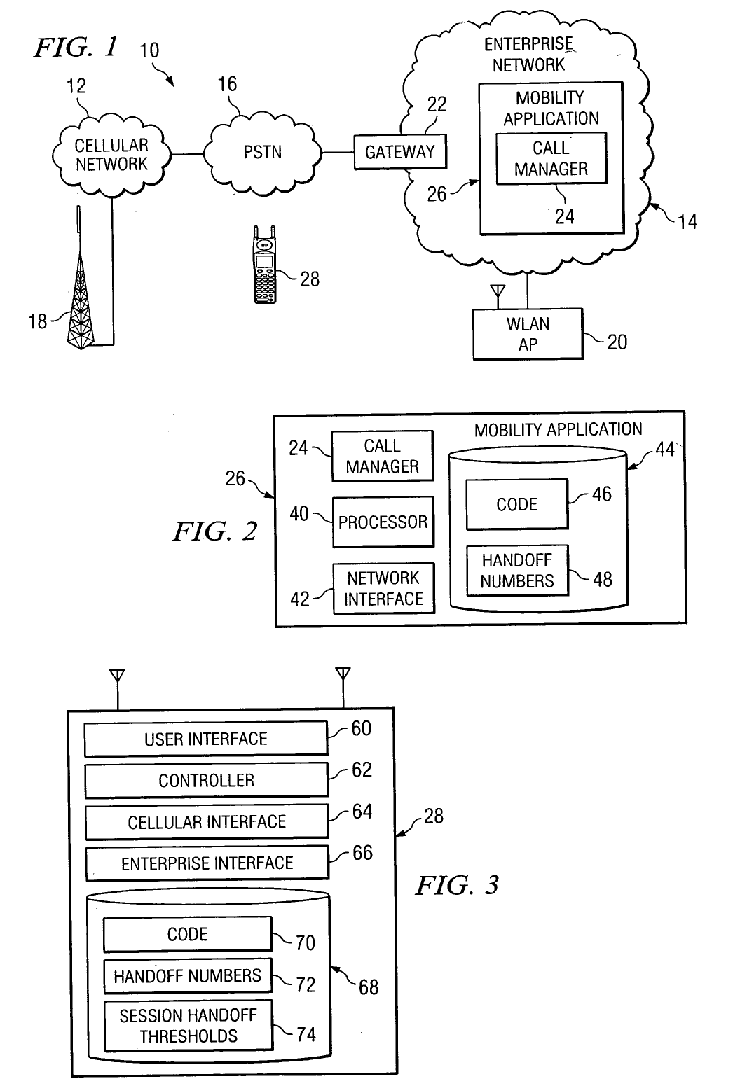

FIG. 1 is a simplified block diagrams that illustrates a communication system, indicated generally at 10, for offering a dually-homed endpoint (alone or in conjunction with a mobility application) that can use traditional enterprise features during a session. In addition, communication system 10 can elegantly perform a handoff between a given network (e.g. a wireless local area network (WLAN)) and a cellular network, while delivering these benefits to the endpoint.

Communication system 10 comprises a cellular network 12 and an enterprise network 14 interconnected through public switched telephone network (PSTN) 16. One or more base stations 18 couple to cellular network 12, and one or more access points 20 couple to enterprise network 14. Enterprise network 14 includes a gateway 22, a call manager 24, and a mobility application 26. System 10 also includes mobile station 28. In general, mobile station 28 may communicate with a remote device through cellular network 12 using base station 18 and/or through enterprise network 14 using access point 20. The elements of system 10 can operate to permit mobile station 28 to maintain a communication session that is handed between cellular network 12 and enterprise network 14. According to particular embodiments, mobility application 26 and/or mobile station 28 utilize one or more of various private branch exchange (PBX) functions to effect handoff between cellular network 12 and enterprise network 14.

Communication system 10 executes an effective and a superlative handoff, whereby the call is anchored in enterprise network 14 (e.g. via mobility application 26). When a call is placed, the call lands on mobility application 26, which recognizes, and is aware of, the call. Hence, when mobile station 28 moves to cellular network 12, mobility application 26 receives a “silent call” from mobile station 28 and, in response to the silent call, mobility application 26 collaborates with call manager 24 to switch (or to transfer [on the fly]) the call. In a similar, reciprocal fashion, when mobile station 28 moves back to enterprise network 14 it communicates with mobility application 26, which transfers the call from a cellular call leg to a voice over IP (VoIP) call leg.

The transfer can be executed in several ways, but the net effect of the transfer is that a real-time protocol (RTP) stream remains constant such that voice traffic can be understood. The RTP stream is essentially switched back and forth from a voice gateway and the VoIP handset platform. One problem associated with this operation is that when a call is made to mobility application 26 (which is generally anchoring the call), mobility application 26 needs to coordinate feature invocation. In addition, the situation is made even more challenging when mobile station 28 roams to cellular network 12.

In accordance with the teachings of the present invention, communication system 10 addresses these issues and others in the following manner. One functionality provided by mobility application 26 is to keep track of a feature state (e.g. hold, transfer, conference, etc.). Mobility application 26 may also translate between dual tone multi-frequency (DTMF) feature-codes and IP-PBX VoIP feature invocation, as appropriate. (Note that DTMF represents the system used by touch-tone telephones. DTMF assigns a specific frequency (consisting of two separate tones) to each key so that it can easily be identified by a microprocessor.) This would enable IP-PBX features (e.g. hold, caller ID, display functions, redirect, three-way calling, barge, web-browsing, etc.) to be provided to mobile station 28 when the dual-mode phone is in cell network 12: even when there is no simultaneous data path. These operations also offer feature transparency across handoff scenarios. One operation of communication system 10 is to have the feature-invocation from the dual-mode phone. This could be provided by communicating directly with mobility application 26 and, then, having mobility application 26 invoke the feature on the call-leg between mobility application 26 and the IP-PBX/far-end. When the dual-mode phone (e.g. mobile station 28) moves to cell network 12, it invokes features by dialing or initiating the corresponding DTMF codes. Mobility application 26 then maps the codes to the appropriate VoIP feature invocation signaling, and then continues to invoke them on the call-leg between itself and the IP-PBX/far-end. It is critical to note that the feature proxy element, as detailed extensively herein, can exist independent of a handoff. Indeed, such applications may be the dominating topology/arrangement of communication system 10. However, the feature delivery mechanism outlined herein could readily be executed during a handoff.

In operation of an example embodiment, when mobile station 28 goes to cellular network 12, there is a functionality in mobility application 26 that invokes features on the end user's behalf. From an architecture perspective, when mobile station 28 is in enterprise network 14 it can represent itself in such endeavors. However, once mobile station 28 moves to cellular network 12, it can no longer participate in such signaling. Thus, some device or element should offer a phone feature proxy function for mobile station 28 (for the purpose of invoking the feature), as well as for the other participant (called party or calling party). Without such a proxy feature, mobile station 28 becomes a “dumb device” that cannot take full advantage of a number of network capabilities. Communication system 10 overcomes this potential deficiency in providing an optimal proxy functionality that allows mobile station 28 to realize the benefits that are generally accorded to it in enterprise network 14. This phone feature proxy can reside in mobility application 26 (and/or mobile station 28) or in any other suitable location or element, where appropriate and based on particular needs.

Note that for purposes of teaching and discussion, it is useful to provide some overview as to the way in which the tendered invention operates. The following foundational information describes some of the problems/arrangements that may be solved/addressed by the present invention. This general information may be viewed as a basis from which the present invention may be properly explained. Such information is offered earnestly for purposes of explanation only and, accordingly, should not be construed in any way to limit the broad scope of the present invention and its potential applications.

When a handoff occurs, mobility application 26 or a call agent is able to suspend an old call leg via some method and then attach the old communication session to the new inbound call leg. From a feature handoff point of view, there are a couple topologies. If mobility application 26 is positioned between mobile station 28 and the call agent, then it can learn of the feature state simply because it is part of the communications path. If mobility application 26 does not sit between mobile station 28 and the call agent, then, as part of the handoff, mobile station 28 needs to communicate a snapshot of the current calls being managed by the station (i.e. feature state and call state information).

Mid-call features (such as hold, transfer, and conference) are the features most at risk of having problems with mobile station 28 because the held call (either hold, transfer hold, or conference hold) may be present for a significant amount of time while the call consults on some other call. When mobile station 28 needs to communicate information to a mobile application that is providing feature handoff services, it need communicate only specific information regarding these “meta-states,” not information as to the detailed internal state of the call. For instance, if mobile station 28 has one call on transfer hold and one active call, then when the handover occurs, mobility application 26 needs to ensure that media of the active call is resumed while the held call does not. When a completion feature stimulus (e.g. DTMF) arrives from the phone through the PSTN to mobility application 26, the application can then finish the feature transaction that started while the phone was in the enterprise.

In one embodiment, mobile station 28 dials a single handoff number, to which mobility application 26 connects the active call. Mobility application 26 takes control of the held leg, but does not necessarily connect it to anything. If mobility application 26 receives a resume signal, mobility application 26 places the active leg on hold, resumes the held call, and associates the held call with the inbound PSTN leg. If mobility application 26 receives a transfer or conference completion signal, then mobility application 26 passes the completion signal up the active leg, which should finish the transfer or conference.

In another embodiment, mobile station 28 dials a handoff number per call (held or active): held calls are handled first. When receiving a handoff call, mobility application 26 connects the call (held or active) to the inbound PSTN leg. If the call was in a held state when the connect occurs, mobile station 28 invokes a GSM hold on the call. If the call was active when the connect occurs, mobile station 28 waits. If the user then invokes resume/transfer/conference, the feature is processed by the serving MSC natively. Feature signaling would not necessarily be via DTMF but, rather, via whatever method the MSC provided.

This feature stimulus need not be manually provided as a keypad button press by the user. The phone can conceal the invocation of the feature through its UI. For instance, within the enterprise, the feature operation may have been provided via a context-sensitive soft key, which resulted in a call signal to the call agent. In the WAN, no such call signals can get through. But if the phone realizes it is handing off a feature, when the user presses the soft key, the handset can inject a DTMF tone into the media.

Cellular network 12 represents communications equipment, including hardware and any appropriate controlling logic, for providing wireless telephony services using cellular protocols and technology. Various cellular protocols and technologies may be used by cellular network 12, including but not limited to global system for mobile communications (GSM), time division multiple access (TDMA), code division multiple access (CDMA), and any other appropriate analog or digital cellular protocol or technology. Furthermore, cellular network 12 may utilize signaling system 7 (SS7) protocol for signaling purposes. Cellular network 12 may include any number of base stations 18, as well as base station controllers, mobile switching centers, and other appropriate communications equipment for use in communicating with mobile station 28 and PSTN 16. Thus, as illustrated, cellular network 12 may couple to base station 18 to receive and transmit wireless signals to and from mobile station 28.

Enterprise network 14 represents communications equipment, including hardware and any appropriate controlling logic, for interconnecting elements coupled to enterprise network 14. Thus, enterprise network 14 may represent a local area network (LAN), a wide area network (WAN), and/or any other appropriate form of network. Furthermore, elements within enterprise network 14 may utilize circuit-switched and/or packet-based communication protocols to provide for wireline telephony services. For example, elements within enterprise network 14 may utilize Internet Protocol (IP). In addition, elements within enterprise network 14 may utilize wireless standards such as the 802.11 family of wireless standards to provide for wireless telephony services. Note that the 802.11 family of wireless standards includes, among others, 802.11a, 802.11b, and 802.11g. Enterprise network 14 may also utilize interactive voice response (IVR). Enterprise network 14 may include any number of wireless network devices 20, gateways 22, call managers 24, and other appropriate communications equipment for use in communicating with mobile station 28 and PSTN 16. In the embodiment illustrated, enterprise network 14 includes access point 20, gateway 22, call manager 24, and mobility application 26. Access point 20 represents communications equipment, including hardware and any appropriate controlling logic, for providing wireless access to enterprise network 14. Access point 20 may utilize one or more of the 802.11 standards. However, any appropriate wireless standard or protocol may be used.

Note that both cellular network 12 and enterprise network 14 represent a series of points or nodes of interconnected communication paths for receiving and transmitting packets of information that propagate to or from an end user or mobile station 28. A subscription or an agreement may be provided by either of the networks to offer cellular service to an end user of mobile station 28. Both networks offer a communicative interface between mobile station 28 and any suitable location within or external to communication system 10 and, thus, may be representative of a GPRS service provider or any suitable LAN, WLAN, metropolitan area network (MAN), WAN, virtual private network (VPN), or any other appropriate architecture or system that facilitates communications in a network environment. Each network may implement a user datagram protocol (UDP)/Internet protocol (UDP/IP) communication language protocol in a particular embodiment of the present invention. Communication system 10 may utilize any form of transmission control protocol (TCP)/IP, or alternatively implement any other suitable communications protocol for transmitting and receiving data or information within communication system 10.

Gateway 22 represents communications equipment, including hardware and any appropriate controlling logic, for interconnecting enterprise network 14 with cellular network 12 and/or PSTN 16. Gateway 22 may be used to convert communications between different communication protocols. For example, gateway 22 may convert communications received from cellular network 12 in SS7 protocol to any of various other protocols that may be used by enterprise network 14, such as protocols associated with the an integrated services digital network (ISDN) standard in the case of circuit-switched trunking and H.323, session initiation protocol (SIP), or other appropriate protocols in the case of IP-based trunking.

Call manager 24 represents communications equipment, including hardware and any appropriate controlling logic, for providing telephony services over enterprise network 14. For example, call manager 24 may support voice over IP (VoIP) communications, using any of various protocols such as SIP, signaling connection control point (SCCP) protocol, media gateway control protocol (MGCP), H.323, and/or any other appropriate protocol for VoIP. Furthermore, call manager 24 may act as an IP PBX and support PBX functions, such as hold, park, transfer, redirect, and/or other high level and low level call management features.

Mobility application 26 represents a server in one embodiment of the present invention, but alternatively could be replaced with any other appropriate device that facilitates the operations detailed herein. Mobility application 26 includes any suitable collection of hardware, software, and controlling logic to support delivery of features to an endpoint. Mobility application 26 could also support a handoff between cellular network 12 and enterprise network 14. For example, mobility application 26 may, when appropriate, utilize PBX features to effect handoff of a communication session between cellular network 12 and enterprise network 14. The feature proxy element, which is facilitated by mobility application 26, can invoke features across handoff (e.g. invoke a hold feature on the WLAN side, perform a handoff, and then resume the call on the cellular side). Also, call transfer and hold/resume operations could easily be performed by the feature proxy.

It should also be noted that the internal structure of mobility application 26 and mobile station 28 are malleable and can be readily changed, modified, rearranged, or reconfigured in order to achieve their intended operations as they pertain to the handoff function outlined herein in this document. As identified supra, software and/or hardware may reside in these elements in order to achieve the teachings of the phone proxy features of the present invention. However, due to their flexibility, these elements may alternatively be equipped with (or include) any suitable component, device, application specific integrated circuit (ASIC), processor, microprocessor, algorithm, read-only memory (ROM) element, random access memory (RAM) element, erasable programmable ROM (EPROM), electrically erasable programmable ROM (EEPROM), field-programmable gate array (FPGA), or any other suitable element or object that is operable to facilitate the operations thereof. Considerable flexibility is provided by the structures of mobility application 26 and mobile station 28 in the context of communication system 10 and, accordingly, they should be construed as such.

PSTN 16 represents communications equipment, including hardware and any appropriate controlling logic, through which cellular network 12 and enterprise network 14 may communicate. PSTN 16 may include switches, wireline and wireless communication devices, and any other appropriate equipment for interconnecting cellular network 12 and enterprise network 14. PSTN 16 may include portions of public and private networks providing network transport services between various geographic areas and networks.

Mobile station 28 represents a mobile device, including hardware and any appropriate controlling logic, capable of communicating with remote devices through cellular network 12 and enterprise network 14 and maintaining communication sessions with remote devices during handoff between cellular network 12 and enterprise network 14. Mobile station 28 may communicate through cellular network 12 using base station 18 and through enterprise network 14 using access point 20. Furthermore, mobile station 28 may interact with call manager 24 and/or mobility application 26 when appropriate to utilize PBX features to effect handoff between cellular network 12 and enterprise network 14. Note that mobile station 28 may provide appropriate feedback to an end user in the presence (or absence) of feedback from a given network/device (e.g. a PBX).

In operation, mobile station 28 may initiate and receive telephone calls through cellular network 12 and/or enterprise network 14 to establish communication sessions with remote devices. Note that, as used herein, a remote device refers to any communications device capable of establishing communications sessions with mobile station 28, such as devices located in cellular network 12, enterprise network 14, PSTN 16, or other linked networks. Furthermore, as used herein, a communication session refers to the transfer of voice, video, data, and/or other information between two or more communication devices. For example, according to particular embodiments a communication session may involve a call between two communication devices or a conference call involving two or more communication devices.

When mobile station 28 is in an area serviced by cellular network 12 and/or enterprise network 14, callers who dial a telephone number or other appropriate identifier of mobile station 28 may initiate a communication session with mobile station 28 through an appropriate network. Similarly, mobile station 28 may dial a telephone number or other appropriate identifier of a remote device and initiate a communication session with the remote device through an appropriate network. Thus, mobile station 28 may function in two modes simultaneously or separately. For example, when in an area serviced by access point 20, mobile station 28 may act as an 802.11 wireless telephony device. When in an area serviced by base station 18, mobile station 28 may act as a cellular phone. These areas may or may not overlap.

Handoff may occur when mobile station 28 travels from an area serviced by cellular network 12 to an area serviced by enterprise network 14. Handoff may also occur in the opposite direction, when mobile station 28 travels from an area serviced by enterprise network 14 to an area serviced by cellular network 12. However, handoff may occur at any other appropriate time. For example, handoff may occur when mobile station 28 is located in an area serviced by both network types due to a predetermined preference of one type of network, due to a spontaneous choice of a user of mobile station 28, or in response to analyzing error rates or other data associated with signaling provided by one or both types of networks. For example, error rates may be associated with signal strengths of base station 18 and access point 20, and may be dependent upon a location of mobile station 28.

In general, mobile station 28 and/or mobility application 26 may utilize PBX features such as hold, park, transfer, redirect, and other high level and low level PBX functions to provide for handoff between cellular network 12 and enterprise network 14. Mobile station 28 may couple to call manager 24 or mobility application 26 through parallel call legs through two networks. The PBX feature may be used to terminate use of an old call leg and initiate use of a new call leg to effect handoff of a communication session from the old call leg to the new call leg.

In some embodiments, anchoring a communication session in enterprise network 14 may provide for control of the communication session during handoff. Anchoring a communication session in enterprise network 14 represents routing signaling through enterprise network 14. When signaling and data flow to mobile station 28 through base station 18, anchoring the communication session in enterprise network 14 may be particularly useful, since enterprise network 14 might otherwise be excluded from the signaling path. If enterprise network 14 is excluded from the signaling path, mobility application 26 and call manager 24 cannot process handoff of the communication session.

Various methods may be used to anchor a communication session in enterprise network 14. Calls placed to mobile station 28 may be anchored in enterprise network 14. For example, cellular network 12 may be provisioned to route calls directed to the telephone number of mobile station 28 to enterprise network 14. Furthermore, mobility application 26 may control the cellular number associated with mobile station 28. Mobility application 26 may indicate to cellular network 12 when mobile station 28 is registered with enterprise network 14 so that when calls are made to the telephone number, cellular network 12 will obtain a handoff number associated with enterprise network 14 from mobility application 26. In addition, a separate enterprise telephone number may be associated with mobile station 28 so that calls to the separate enterprise telephone number will route through enterprise network 14, which can extend the call to mobile station 28 through cellular network 12.

After receiving a telephone call intended for mobile station 28, call manager 24 and/or mobility application 26 may include itself in a signaling path associated with the resulting communication session, whether the signaling path proceeds through cellular network 12 or enterprise network 14. Note that when a remote device exists outside enterprise network 14, for example on cellular network 12, and mobile station 28 is outside of a coverage area of access point 20, hairpinning media through gateway 22 may be appropriate. That is, media communicated to gateway 22 from the remote device may be routed to mobile station 28 without requiring the media to pass through enterprise network 14. Similarly, media communicated to gateway 22 from mobile station 28 may be routed to the remote device without requiring the media to pass through enterprise network 14.

Calls placed by mobile station 28 may be anchored in enterprise network 14 by first seeking to utilize enterprise network 14 when a user of mobile station 28 dials a telephone number. To the extent mobile station 28 is in an area serviced by access point 20, any communication session may be anchored in enterprise network 14 by utilizing access point 20. When mobile station 28 is located outside the area serviced by access point 20, mobile station 28 may first couple to mobility application 26 through cellular network 12. For example, cellular network 12 may be provisioned to redirect calls into enterprise network 14. Mobility application 26 may then couple mobile station 28 to the intended remote device by dialing the phone number on behalf of mobile station 28. Alternatively or in addition, mobile station 28 may dial an IVR service provided by enterprise network 14. A user of mobile station 28 may then use the IVR service to dial the target number.

Anchoring a call in enterprise network 14 may allow mobile station 28 alone or in combination with mobility application 26 to invoke PBX features within enterprise network 14, such as PBX features controlled by call manager 24, to effect handoff between enterprise network 14 and cellular network 12. For example, consider the case in which a caller in PSTN 16 calls mobile station 28 while mobile station 28 is an area serviced by base station 18. In this case, if the phone number of mobile station 28 is associated with enterprise network 14, call signaling travels through PSTN 16 and enters enterprise network 14 through gateway 22. Gateway 22, alone or in combination with call manager 24 and/or mobility application 26, extends the call back through PSTN 16 and cellular network 12 to mobile station 28. Using appropriate communications, mobile station 28 or mobility application 26 may invoke a PBX feature when appropriate to effect handoff from cellular network 12 to enterprise network 14. For example, if mobile station 28 enters or is located in an area serviced by access point 20, and mobile station 28 desires to utilize enterprise network 14, steps may be taken to effect handoff from cellular network 12 to enterprise network 14 using a PBX feature hosted by enterprise network 14. According to a particular embodiment, dial tone multi-frequency (DTMF) signals may be communicated to mobility application 26 or call manager 24 to invoke a PBX feature.

One PBX feature that may be utilized to effect handoff is a park feature. Of course, other PBX features may be utilized. For example, the PBX feature transfer may be used to link together an existing call leg with a new call leg. For example, a new call leg associated with mobile station 28 may be transferred to a call leg associated with a remote device to reestablish a communication session. Similarly, a call leg associated with a remote device may be transferred to a new call leg associated with mobile station 28 to reestablish a communication session.

To activate a PBX feature, mobile station 28 may use any appropriate signaling. When mobile station 28 is receiving wireless service from access point 20, mobile station 28 may communicate signals to enterprise network 14 to invoke the PBX feature. For example, when leaving an area serviced by access point 20, mobile station 28 may invoke the PBX feature or request that mobility application 26 invoke the PBX feature. As another example, when mobile station 28 enters an area service by access point 20, mobile station 28 may invoke the PBX feature in the same way. For example, the park retrieval operation may be invoked.

When mobile station 28 is receiving wireless service from base station 18, mobile station 28 may communicate the signals to enterprise network 14 through cellular network 12 to invoke the PBX feature. According to particular embodiments a signal may be communicated through cellular network 12 using IVR or DTMF. Within enterprise network 14, the signals may activate a PBX feature. For example, when mobile station 28 determines that enterprise network 14 may be available, mobile station 28 may communicate a sequence of signals corresponding to a feature activation code through cellular network 12.

Thus, mobile station 28 and/or mobility application 26 may take action to hand off communication sessions between cellular network 12 and enterprise network 14 with little or no changes to other elements of system 10.

Note that communication system 10 represents one embodiment of a system that supports handoff between cellular and enterprise wireless networks. Various alternative embodiments are possible. For example, while in the illustrated embodiment enterprise network 14 couples to cellular network 12 through PSTN 16 using gateway 22, various other embodiments may include enterprise network 14 coupling to cellular network 12 in other ways. For example, enterprise network 14 may couple to cellular network 12 using a service provider that supports VoIP. Thus, in alternative embodiments, cellular network 12 and gateway 22 may not be included in communication system 10.

FIG. 2 is a block diagram illustrating functional components of mobility application 26. In the embodiment illustrated, mobility application 26 includes call manager 24, as well as a processor 40, a network interface 42, and a memory 44. These functional elements can operate to support handoff of active communication sessions when mobile station 28 roams between cellular network 12 and enterprise network 14.

Processor 40 controls the operation and administration of elements within mobility application 26. For example, processor 40 operates to process information received from network interface 42 and memory 44. Processor 40 includes any hardware and/or logic elements operable to control and process information. For example, processor 40 may be a programmable logic device, a microcontroller, and/or any other suitable processing device.

Network interface 42 communicates information to and receives information from devices coupled to enterprise network 14. For example, network interface 42 may communicate with gateway 22, call manager 24, and access point 20. Furthermore, network interface 42 may receive information from and transmit information to remote devices as well as mobile station 28. Thus, network interface 42 includes any suitable hardware or controlling logic used to communicate information to or from elements coupled to mobility application 26.

Memory 44 stores, either permanently or temporarily, data and other information for processing by processor 40 and communication using network interface 42. Memory 44 includes any one or a combination of volatile or nonvolatile local or remote devices suitable for storing information. For example, memory 44 may include random access memory (RAM), read only memory (ROM), magnetic storage devices, optical storage devices, or any other suitable information storage device or a combination of these devices. As illustrated, memory 44 may include one or more memory modules, such as code 46 and handoff numbers 48.

Code 46 includes software, executable files, and/or appropriate logic modules capable when executed to control the operation of mobility application 26. For example, code 46 may include executable files capable of supporting handoff between cellular network 12 and enterprise network 14. Code 46 may include instructions to enable mobility application 26 to utilize PBX features. Handoff numbers 48 include E.164 telephone numbers that mobility application 26 may use and/or provide to mobile station 28 for use in effecting handoff between cellular network 12 and enterprise network 14. For example, mobility application 26 may be assigned static E.164 numbers for handoff purposes.

In operation of one example that involves a park feature, network interface 42 may receive an indication from mobile station 28 that mobile station 28 intends to utilize a second network, for example cellular network 12. In some embodiments, processor 40 may communicate a handoff number selected from handoff numbers 48 to mobile station 28 through network interface 42. Alternatively or in addition, when mobile station 28 parks the communication session and receives a park number from call manager 24, mobility application 26 may associate the park number with a handoff number 48 selected from handoff numbers 48. However, note that while in some embodiments mobile station 28 may initiate park, mobility application 26 may initiate park in other embodiments. Network interface 42 may communicate the handoff number to mobile station 28 so that mobile station 28 may dial the handoff number.

When mobile station 28 dials the handoff number, a stealth or silent call to enterprise network 14 is initiated. Gateway 22 or call manager 24 may direct the incoming call leg to network interface 42. Processor 40 may then couple the incoming leg to the parked leg. For example, processor 40 may invoke a PBX feature. Processor 40 may activate a park retrieval operation. Alternatively, processor 40 may invoke transfer. In some embodiments, mobility application 26 may internally bridge the parked leg to the incoming leg to retain control over communication sessions. Retaining control may enable later handoffs when appropriate. In other embodiments, mobility application 26 may redirect incoming calls to call manager 24 for coupling to a parked call.

Note that mobility application 26 may utilize session description protocol (SDP) to bridge media. Use of SDP may provide for more secure handoff by associating incoming legs with parked legs only when SDP identifiers match. Furthermore, mobility application may use any appropriate protocol to communicate with other elements of system 10. For example, mobility application 26 may utilize Java telephony application programming interface (JTAPI) to interact with call manager 24.

While this example includes specific functional components for mobility application 26, mobility application 26 may include any collection and arrangement of components, including some or all of the enumerated functional components, for supporting handoff between cellular network 12 and enterprise network 14. Moreover, mobility application 26 contemplates implementing each of the functional components using any suitable combination and arrangement of hardware and/or logic, and implementing any of the functionalities using a computer program stored on a computer-readable medium. Furthermore, mobility application 26 may be implemented as a stand-alone device, or aspects of mobility application 26 may be distributed among various devices within enterprise network 14. Alternatively, in some embodiments mobility application 26 may be incorporated into call manager 24.

FIG. 3 is a block diagram illustrating functional components of mobile station 28. In the embodiment illustrated, mobile station 28 includes a user interface 60, a controller 62, a cellular interface 64, an enterprise interface 66, and a memory 68. In general, mobile station 28 may establish communication sessions with remote devices through interaction with cellular network 12 and/or enterprise network 14. Moreover, mobile station 28 may effect handoff between cellular network 12 and enterprise network 14.

User interface 60 allows a user of mobile station 28 to input information into mobile station 28 and receive information outputted by mobile station 28. For example, user interface 60 may receive audio information from a user of mobile station 28. User interface 60 may also allow the user to dial telephone numbers and select from various features made available by mobile station 28. In addition, audio information may be outputted by user interface 60 to the user. Thus, user interface 60 may include a microphone, speaker, keypad, and/or other appropriate devices for inputting and outputting information.

Controller 62 controls the operation and administration of the elements within mobile station 28. For example, controller 62 operates to process information and/or commands received from user interface 60, cellular interface 64, enterprise interface 66, and memory 68. Controller 62 includes any hardware and/or logic elements operable to control and process information. For example, controller 62 may be a microcontroller, processor, programmable logic device, and/or any other suitable processing device.

Cellular interface 64 communicates information to and receives information from cellular network 12. For example, cellular interface 64 may communicate and receive audio information and signaling data associated with telephone calls placed through cellular network 12. Thus, cellular interface 64 includes any suitable hardware or controlling logic used to communicate information to or from elements coupled to mobile station 28.

Enterprise interface 66 communicates information to and receives information from enterprise network 14. For example, enterprise interface 66 may communicate and receive audio information and signaling data associated with telephone calls placed through enterprise network 14. Thus, enterprise interface 66 includes any suitable hardware or controlling logic used to communicate information to or from elements coupled to mobile station 28.

Note that, as illustrated, mobile station 28 includes multiple antennas. Use of multiple antennas may allow mobile station 28 to simultaneously couple to multiple wireless networks. For example, a first antenna couple to cellular interface 64 to provide for communication with cellular network 12, while a second antenna may couple to enterprise interface 66 to provide for communication with enterprise network 14. However, mobile station 28 may include any number of antennas, including one antenna, to provide for simultaneous and/or serial communications with various networks.

Memory 68 stores, either permanently or temporarily, data and other information for processing by controller 62 and communication using user interface 60, cellular interface 64, and/or enterprise interface 68. Memory 68 includes any one or a combination of volatile or nonvolatile devices suitable for storing information. For example, memory 68 may include RAM, ROM, magnetic storage devices, optical storage devices, or any other suitable information storage device or a combination of these devices. As illustrated, memory 68 may include one or more memory modules, such as code 70, handoff numbers 72, and session handoff thresholds 74.

Code 70 includes software, executable files, and/or appropriate logic modules capable when executed to control the operation of mobile station 28. For example, code 70 may include executable files capable of effecting handoff between cellular network 12 and enterprise network 14. Code 70 may include instructions to enable mobile station 28 to place stealth calls to create new call legs for handoff purposes. Code 70 may also include instructions to enable mobile station 28 to utilize (and to invoke) PBX features. Handoff numbers 72 include E.164 telephone numbers that mobile station 28 may use to effect handoff between cellular network 12 and enterprise network 14. For example, mobile station 28 may dial E.164 numbers to place stealth calls. Session handoff thresholds 74 include data, such as acceptable and unacceptable error rates associated with communication sessions. Session handoff thresholds 74 may be used by mobile station 28 to determine when to seek handoff between cellular network 12 and enterprise network 14. More specifically, session handoff thresholds 74 may specify thresholds for use when mobile station 28 has an active communication session.

In operation, controller 62 may maintain registration with call manager 24 when mobile station 28 is located within an area serviced by access point 20. Controller 62 may operate to communicate voice data received through user interface 60 as well as signaling data through base station 18 and/or access point 20 to cellular network 12 and/or enterprise network 14. Controller 62 may also operate to communicate voice data received through cellular interface 64 and/or enterprise interface 66 to a user of mobile station 28 through user interface 60. In addition, controller 62 may use session handoff thresholds 74 to determine when to effect handoff between cellular network 12 and enterprise network 14. For example, controller 62 may determine that an session handoff threshold 74 associated with communication session using enterprise interface 66 has been exceeded, and controller 62 may register with cellular network 12 using cellular interface 64 and place a stealth call through cellular network 12 to mobility application 26 using a handoff number 72. Furthermore, controller 62 may communicate commands to call manager 24 and/or mobility application 26 through cellular interface 64 and/or enterprise interface 66 to utilize PBX features for handoff purposes.

While this example includes specific functional components for mobile station 28, mobile station 28 may include any collection and arrangement of components, including some or all of the enumerated functional components, for communicating with remote devices using cellular network 12 and/or enterprise network 14 and effecting handoff between cellular network 12 and enterprise network 14 using PBX features. Moreover, mobile station 28 contemplates implementing each of the functional components using any suitable combination and arrangement of hardware and/or logic. Thus, in one embodiment mobile station 28 is a mobile phone. In other embodiments, mobile station 28 may be a personal digital assistant (PDA), laptop computer, or other device operable to establish communications with cellular network 12 and enterprise network 14.

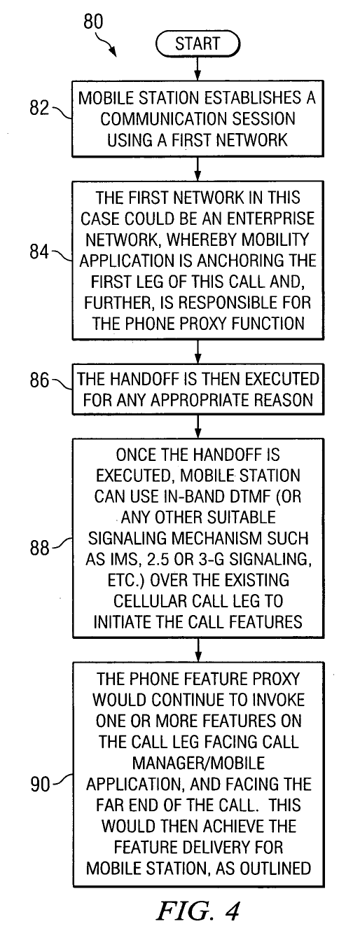

FIG. 4 is a flowchart illustrating a method 80 for offering a phone proxy feature for mobile station 28, which is engaged in a communication session involving cellular network 12 and enterprise network 14. Note that there are two methods that are covered by FIG. 4. The first method relates to when the phone feature proxy invokes features for mobile station 28 all the time, whether it is residing in the VoIP network or in cellular network 12. The second method relates to a selected invocation of features for mobile station 28. Mobile station 28 establishes a communication session using a first network at step 82. Note that mobile station 28 may initiate the communication session when a user of mobile station 28 dials a phone number, or mobile station 28 may establish the communication session when a user of mobile station 28 accepts an inbound call from a remote device. Also note that the first network may be either cellular network 12 or enterprise network 14, as the proposed method can easily be executed in both operative directions. The first network in this case could be enterprise network 14, whereby mobility application 26 is anchoring the first leg of this call and, further, is responsible for the phone feature proxy as described herein. (Note also that suitable elements are provided in mobile station 28 to facilitate the phone feature proxy.) This anchoring is reflected by step 84. There is also a second leg (or generic connection platform) between the phone feature proxy function (which in this example is included in mobility application 26) and call manager 24. This achieves the appropriate signaling (e.g. between the protocol stack and the key handling, display, etc.) for mobile station 28.

At this point there is one connection between mobile station 28 and the feature proxy and there is (in the context of the actual call) a leg between the feature proxy and the remote endpoint of the call (via call manager 24 or mobility application 26). The handoff is then executed for any appropriate reason at step 86. For example, mobile station 28 may monitor data associated with the first network until the data exceeds one of session handoff thresholds 74, which may cause mobile station 28 to determine to utilize the second network. Alternatively or in addition, mobile station 28 may determine to utilize the second network when a preferred network becomes available. For example, mobile station 28 may be programmed to utilize enterprise network 14 when enterprise network 14 is available due to reduced costs associated with use of cellular network 12.

Once the handoff is executed, mobile station 28 can use in-band DTMF (or any other suitable signaling mechanism such as IMS, 2.5 or 3-G signaling, etc.) over the existing cellular call leg at step 88. Virtually any data connection could facilitate such signaling. The feature proxy would continue to invoke one or more features on the call leg, which faces call manager 24/mobile application 26 and the far end of the call. This would then achieve the feature delivery for mobile station 28, as described herein. As can be readily appreciated, with the proffered architecture, features in cellular network 12 are offered to an end user without requiring a simultaneous voice and data connections. In addition, features may be invoked and realized during a handoff.

As a slight variation to the preceding operations, the feature proxy can behave such that it is only activated after the handoff to cellular network 12. Before handoff, the feature proxy is monitoring the signaling (e.g. being in communication with mobile station 28 or being in the signaling path, etc.) such that it can keep track of the feature state. Thus, it can passively monitor the protocol and recognize the state of the call. This allows the feature proxy to act immediately during critical times once the handoff occurs.

The preceding flowcharts illustrate particular methods for effecting handoff between cellular network 12 and enterprise network 14. However, these flowcharts illustrate only exemplary methods of operation. While discussion sometimes focuses on handoff in the enterprise-to-cellular direction, similar techniques may be used to provide for handoff in the cellular-to-enterprise direction. Furthermore, communication system 10 contemplates devices using any suitable techniques, elements, and applications for performing these functions. Thus, many of the steps in the flowcharts may take place simultaneously and/or in different orders than as shown. In addition, the devices may use methods with additional steps or fewer steps, so long as the methods remain appropriate. Moreover, other devices of system 10 may perform similar techniques to support handoff between cellular network 12 and enterprise network 14.

It is critical to note that the stages and steps in FIG. 4 illustrate only some of the possible scenarios and operations that may be executed by, or within, the present system. Some of these stages and/or steps may be deleted or removed where appropriate, or these stages and/or steps may be modified, enhanced, or changed considerably without departing from the scope of the present invention. In addition, a number of these operations have been described as being executed concurrently with, or in parallel to, one or more additional operations. However, the timing of these operations may be altered. The preceding example flows have been offered for purposes of teaching and discussion. Substantial flexibility is provided by the tendered architecture in that any suitable arrangements, chronologies, configurations, and timing mechanisms may be provided without departing from the broad scope of the present invention. Accordingly, communications capabilities, data processing features and elements, suitable infrastructure, and any other appropriate software, hardware, or data storage objects may be included within communication system 10 to effectuate the tasks and operations of the elements and activities associated with executing handoff functions.

Although the present invention has been described in detail with reference to particular embodiments, it should be understood that various other changes, substitutions, and alterations may be made hereto without departing from the spirit and scope of the present invention. The illustrated network architecture of FIG. 1 has only been offered for purposes of example and teaching. Suitable alternatives and substitutions are envisioned and contemplated by the present invention: such alternatives and substitutions being clearly within the broad scope of communication system 10. For example, the use of gateway 22 could be supplanted by bridges, switches, routers or any other suitable devices that are conducive to network communications.

Numerous other changes, substitutions, variations, alterations, and modifications may be ascertained to one skilled in the art and it is intended that the present invention encompass all such changes, substitutions, variations, alterations, and modifications as falling within the spirit and scope of the appended claims.

What is claimed is:

1. A mobile station, comprising:
a first wireless interface operable to couple to a first wireless network;
a second wireless interface operable to couple to a second wireless network; and
a controller operable to negotiate a first wireless link with the first wireless network using the first wireless interface, to establish a communication session with a device using the first wireless link, to facilitate the communication session with a second wireless link with the second wireless network using the second wireless interface, and to invoke a selected one of a plurality of private branch exchange features, wherein one or more of the features are delivered to the mobile station via a phone feature proxy function that is enabled by a mobility application that is operable to communicate with the mobile station.

2. The mobile station of claim 1, wherein the mobile station is further operable to invoke one or more of the features by initiating one or more corresponding dual tone multi-frequency (DTMF) codes.

3. The mobile station of claim 1, wherein the controller is further operable to facilitate a session handoff for the mobile station.

4. The mobile station of claim 3, wherein the controller is further operable to facilitate the session handoff in a scenario that includes a selected one of a hold/resume operation and a call transfer operation.

5. The mobile station of claim 1, wherein the controller is further operable to transfer the communication session from the first wireless link to the second wireless link using a call transfer feature.

6. The mobile station of claim 1, wherein the mobile station communicates with the mobility application in order to provide call state and feature state information.

7. The mobile station of claim 1, wherein the mobile station is operable to provide feedback to an end user of the mobile station in a presence or in an absence of feedback being provided via the second wireless network.

8. The mobile station of claim 1, wherein a session handoff is executed in response to the mobile station monitoring data associated with the first network until the data exceeds a selected one of a plurality of session handoff thresholds, the selected session handoff threshold causing the mobile station to utilize the second network.

9. A system for effecting communication between wireless networks, comprising:
a mobility application operable to communicate with a mobile station and to transfer a communication session from a first wireless link to a second wireless link, wherein the mobile station is operable to negotiate a first wireless link with a first wireless network, to establish a communication session with a device using the first wireless link, to facilitate the communication session with a second wireless link with the second wireless network using the second wireless interface, and to invoke a selected one or more of a plurality of private branch exchange features, and wherein one or more of the features are delivered to the mobile station via a phone feature proxy function that is enabled by the mobility application.

10. The system of claim 9, wherein one or more of the features are invoked by leveraging one or more corresponding dual tone multi-frequency (DTMF) codes.

11. The system of claim 10, wherein the mobility application is further operable to map one or more of the codes to one or more voice over IP (VoIP) features provided to the mobile station.

12. The system of claim 9, wherein the mobility application is further operable to initiate a selected one of the private branch exchange features that operates to transfer the communication session from the first wireless link to the second wireless link.

13. The system of claim 12, wherein the mobility application facilitates a session handoff.

14. The system of claim 13, wherein the mobility application is further operable to facilitate the session handoff in a scenario that includes a selected one of a hold/resume operation and a call transfer operation.

15. The system of claim 9, wherein the mobility application further comprises a call manager that is operable to provide one or more telephony services to the mobile station.

16. The system of claim 9, wherein the mobility application keeps track of a feature or a call state of the mobile station.

17. A method facilitating communications between wireless networks, comprising:
negotiating, by a mobile station, a first wireless link with a first wireless network using a first wireless interface;
establishing a communication session between the mobile station and a device using the first wireless link;
facilitating the communication session with a second wireless link with a second wireless network using a second wireless interface; and
invoking a selected one of a plurality of private branch exchange features, wherein one or more of the features are delivered to the mobile station via a phone feature proxy function.

18. The method of claim 17, wherein the invocation of one or more of the features is initiated by one or more corresponding dual tone multi-frequency (DTMF) codes.

19. The method of claim 17, further comprising:
facilitating a session handoff for the mobile station.

20. The method of claim 19, wherein the mobile station is further operable to facilitate the session handoff in a scenario that includes a selected one of a hold/resume operation and a call transfer operation.

21. The method of claim 17, further comprising:
transferring the communication session from the first wireless link to the second wireless link using a call transfer feature.

22. The method of claim 17, further comprising:
monitoring a signal quality of the first wireless link; and
triggering a session handoff when the signal quality drops below a threshold.

23. The method of claim 22, wherein the session handoff is executed in response to the mobile station monitoring data associated with the first network until the data exceeds a selected one of a plurality of session handoff thresholds, the selected session handoff threshold causing the mobile station to utilize the second network.

24. A method for facilitating communications between wireless networks, comprising:
communicating with a mobile station;
transferring a communication session from a first wireless link to a second wireless link, wherein the mobile station is operable to negotiate a first wireless link with a first wireless network, to establish a communication session with a device using the first wireless link, to facilitate the communication session with a second wireless link with the second wireless network using the second wireless interface, and to invoke a selected one or more of a plurality of private branch exchange features; and
delivering one or more of the features to the mobile station via a phone feature proxy function.

25. The method of claim 24, wherein one or more of the features are invoked by leveraging one or more corresponding dual tone multi-frequency (DTMF) codes.

26. The method of claim 24, further comprising:
mapping one or more of the codes to one or more voice over IP (VoIP) features provided to the mobile station.

27. The method of claim 24, further comprising:
initiating a selected one of the private branch exchange features that operates to transfer the communication session from the first wireless link to the second wireless link.

28. The method of claim 24, further comprising:
providing one or more telephony services to the mobile station.

29. The method of claim 24, further comprising:
facilitating a session handoff for the mobile station.

30. The method of claim 29, wherein, based on a quality of the first wireless link, the session handoff is triggered.

31. The method of claim 29, wherein the session handoff is executed in a scenario that includes a selected one of a hold/resume operation and a call transfer operation
